(19) United States
(12) Patent Application Publication
(10) Pub. No.: US 2018/0110202 A1
(43) Pub. Date: Apr. 26, 2018

(54) Apparatus and Method for topical treatments on Animals

(71) Applicant: Ebert Adrian Michael, St. Marys (CA)

(72) Inventor: Ebert Adrian Michael, St. Marys (CA)

(21) Appl. No.: 15/332,089

(22) Filed: Oct. 24, 2016

(51) Int. Cl. A01K 13/00

(52) U.S. Cl. CPC A01K 13/002; A01K 13/003; A01K 13/001

(57) ABSTRACT

A topical supradermal applicator comprises a liquid reservoir adapted to be coupled in liquid transferring relation with a plurality of applicator tines each having a longitudinal extent adapted to bypass an animals coat and including liquid directing channels operable to conduct liquid to topically transfer liquid beneath the coat. The reservoir comprises a graspable bulb-configured handle providing waisted radially opposed accommodation for an operator's opposed digits, around the periphery of the bulb.

### TECHNICAL FIELD

This invention relates to a method and system for the application of various liquids to an animal's skin. Specifically, this invention relates to the use of an object comprising a refillable reservoir and perforated tips to apply various liquid solutions through the coat of an animal and directly onto the skin. This invention is applicable to all animals with a coat or fur preventing liquid from easily reaching the animal's skin.

### BACKGROUND ART

Conventional bathing and washing methods involve the submersion of an animal, or section of an animal, in water for the scrubbing and brushing of the liquid throughout the coat of the animal, with little emphasis on the liquid reaching through the coat to the skin of the animal. While this method may work for the washing of the animal, it often misses bacteria and dirt built up on the skin of the animal. It also requires a large amount of effort to adequately clean the animal. The other conventional method involves the spraying of liquid topically onto an animal. This is also not effective in allowing the liquid to reach the skin, and makes for an unpleasant experience for both the user and the animal.

If the skin of an animal is left uncleansed, bacteria quickly builds up. This results in unpleasant odors, skin irritation, and occasionally illness in the animal. This is more important in animals with thicker coats as it becomes much harder for the liquid to reach through the coat to properly clean the skin. It is apparent that a need exists for a method of applying various liquid solutions directly to the skin of an animal.

The present invention is directed toward providing for such a technique. It is an object of the present invention to provide an applicator and method and a system for the efficient and proper application of various liquids onto the skin of an animal directly through the coat, while allowing this solution to be worked throughout the coat after reaching the skin. It is also an object of this invention to provide a method applying liquid to an animal and fully reaching the skin, without the immersion/submersion of the animal in a liquid. A further object of the invention is to provide a method of cleaning the skin of an animal that requires less time for the owner, and reduces the unpleasantness of the washing to the animal. These and other objects of the invention will be apparent to those skilled in the art from the description that follows.

U.S. Pat. No. 2,139,904 makes provision for capillary bores or passageways extending longitudinally of comb teeth from orifices in the tooth tips, with the upper ends of the bores being vented to the atmosphere. It is necessary only to dip the tooth tips into a shallow tray of treating solution, whereupon a substantial amount of fluid is drawn by capillary attraction into the bores, where it remains until the comb teeth are passed through the hair and into contact with the scalp. Then, by drawing the comb through the hair with the tooth tips held against the scalp, the solution is drawn from the bores by reason of the wiping contact, and is deposited over the scalp adjacent the roots of the hair. The capillary action is passive and more readily clogged, and amenable to only minimal pickup and storage volume of the fluid, and the application rate is limited to the draining rate from the capillary tubes.

U.S. Pat. No. 2,922,425 related to an Applicator for applying Liquid to Hair. It expressly provides for stand-off features specifically adapted to accommodate hair treatments as opposed to scalp treatments. Also unlike the '904 patent mentioned above, provision is made for a reservoir to supply the hair treatment to the applicator tines. As with the '904 patent the applicator tines are arranged in a linear array, although exceptional provision is also made for a circular applicator for applying treatments to produce curls in the hair.

U.S. Pat. No. 5,845,603 discloses a pet bush and flea powder dispenser. The brush dispenser includes a rectangular array of hollow dispenser tines extending orthogonally in relation to an elongated brush handle adapted to be grasped by an operator's hand. The body of the brush includes a flea powder reservoir that supplies power to an electric blower which in turn directs the powder into and through the tines. U.S. Pat. No. 6,367,421 discloses a substantially similar dispenser, and also with an orthogonal tines/handle relationship—both of which have their handles extending laterally beyond or outside of the surface coverage of the tines. In both cases, this makes local application awkward when the handle limits the approaches available to positioning the tines relative to the surface to be treated.

U.S. Pat. No. 6,024,052 discloses a grooming brush in combination with a flea powder dispensing head. The structure overall is very similar to the dispensing array supported by an orthogonally extending handle disclosed in U.S. Pat. No. 5,845,603 above. Here too, the orthogonal handle can interfere with the positioning and transitioning of the dispensing head during a treatment application.

U.S. Pat. No. 6,109,214 discloses a pet brush configured as a mitten including a reservoir adapted to provide for dispensing tines broadly arranged on one side thereof. Large (full open hand sized) dispensing surface with brush coverage as opposed to linear array, but large coverage makes it more difficult to maneuver even in the absence of the linear array problems an orthogonal handle, and very difficult to accurately localize treatment applications. Moreover, the open-handed engagement does not lend itself to the dexterity afforded by opposable digit grip.

U.S. Pat. No. 6,367,421, as mentioned above in the context of both the '603 and '502 patents mentioned supra, is based on an orthogonally extending relationship between an offset cylindrical handle adapted to be gripped between opposed digits, and a dispensing head at one end thereof.

U.S. Pat. No. 6,378,529 discloses a device usable as an applicator comb, comprising a collection of applicator teeth inserted into a tubular body as a supporting element, permitting liquid or gelatinous products to be applied precisely and economically, by having attached to the device a container or receptacle holding the treatment product. The product to be applied may cover all, only the sides or only the base of the applicator teeth, depending on whether the treatment is to be given on the totality of the hair and Scalp, only on the hair or on the base of the hair and in the scalp. Nevertheless, the handle extending well beyond the linear comb-like applicator array, while useful perhaps in applying the treatment to the orb of a human skull, is more problematic in applying a treatment to an animal—especially small quadrupeds, like the miniature dog breeds.

U.S. Pat. No. 6,637,440 discloses a device for applying a product to hair. The device has a dispensing head configured to be coupled to a container. The dispensing head includes an applicator member and a screen. The applicator member includes at least one tooth configured to be placed in contact With hair and moved with respect thereto. Here again, the container is arranged to provide a hand hold for manipulating the dispensing head—and like so many of the above described devices, extends orthogonally from the dispensing head or other applicator source, so as to perhaps be useful in applications to a human head, but awkward in coping with animal applications—again, particularly in the case of quadrupeds, and especially miniature breeds.

U.S. Pat. No. 7,234,419 discloses pet grooming aid which comprises a flexible, elongated handle coupled to a head bearing rigid tines adapted to reach into a pet's fur to its skin. The cylindrical handle in this case, yet again includes a reservoir for treatment fluids, and which extends in laterally offset relation to the dispensing head. The reservoir is coupled through a valve to a manifold within the head that distributes the fluid to tube within each tine. Squeezing the tube forces treatment through the tines and onto the pet's skin. A gate valve prevents fluid from being dispensed unless and until the handle is squeezed. Here again, the handle extends in offset relation to the dispensing head, and potentially complicates the positioning and movement of the dispensing head over the pet's body.

U.S. Pat. No. 7,926,492 discloses horse and/or livestock brush assembly releases a fluid and/or liquid solution directly onto the coat of an animal during brushing. The brush assembly includes a brush base attached to a hose and flow regulator. The brush base comprises a flexible deformable membrane with a plurality of apertures that are, optionally, aligned With apertures in brush bristles for delivery of the fluid and/or liquid solution, and is fitted within an opening of an internal cavity in a brush base. The strap handle in this device performs a function similar to the fully mitten disclosed in the '214 patent mentioned above. In this case the dispensing head is a circular member, and the problem of coping with a laterally offset handle is avoided by attaching a flexible hose to a source of the desired treatment, so as to reduce the difficulties of applying the treatment to a quadruped—although even so, the hose can be problematically entangled between the animals legs.

U.S. Pat. No. 8,118,036 discloses dispensing device, having a hollow stopper configured to act as a one-way valve, for use as a hair dyeing. A comb-like linear applicator array s provided. The nipple-shaped stopper has an aperture at its tip end. The aperture opens toward the outside so that when the operator compresses the plastic bottle the dye is dispensed, and when the operator releases the plastic bottle the aperture reverts to a closed position, and the stopper prevents the liquid hair dye from travelling back into the dye reservoir. Here again, the handle/reservoir is arranged in laterally extending offset relation from the dispensing head—useful in dealing with human heads, especially for self-application, but problematic in relation to applying treatments to quadrupeds.

### SUMMARY OF THE INVENTION

### Technical Problem

The problem that has long faced animal groomers, and which continues even now to persist in the art, arises in connection with providing apparatus, methods and the like suited to the grooming of animals, that can support nimble handling of both the animal and the applicator, to facilitate dexterous without distracting the operator or alarming the animal.

### Solution to the Problem

The method and the system of this invention center around the concept of using a device comprising a refillable reservoir on one end and perforated tips on the other that allow liquid to flow from the reservoir and through the tips directly past the animals coat and onto the skin. The tips on this device would be interchangeable, allowing for the application of liquid to the skin of several sizes of animals with varying coat lengths and thicknesses. This invention allows an animal owner to apply liquid placed in the reservoir of the device directly through the perforated tips and onto the skin of the animal. This also allows the liquid to remain on the skin of the animal without the need of brushing. The owner could then brush this liquid into the skin and coat of the animal using the perforated tips of the device. This method effectively avoids the common problem of only having liquid reach the outer coat of the animal, and removes the need for the animal to be submerged in liquid to have the skin cleaned. Some examples of liquids that could be applied to the skin include “leave-it-on” shampoos, “leave-it-on” conditioners, medicated liquids, and other liquids or materials carried by them that are intended to be left on the skin, which is a goal of this invention.

The perforated tips on the device will allow for the easy brushing of liquid throughout the skin and coat of the animal, once the perforated tips have allowed the liquid to reach the skin of the animal.

When operated in the manner prescribed by the method stipulated herein, the animal skin and coat cleaning system of this invention enables the application of various liquids directly to the skin of the animal, as well as the brushing in of this liquid directly after the application. This can be achieved in a short time frame and with minimal discomfort to the animal as there is no submersion.

The method of this invention is particularly suited for animals that have a coat or fur, as well as animals that suffer from skin irritation or those that experience discomfort when partially submerged in liquid.

The present invention advances the art of animal bathing and provides a method and system for the efficient and proper application of a liquid through the coat of an animal directly onto the skin.

In connection with the above, the present invention provides for a topical supradermal applicator comprising a liquid reservoir and applicator tines. The reservoir is adapted to be coupled in liquid transferring relation with a plurality of the applicator tines, each of which has a longitudinal extent adapted to bypass an animal's coat. The tines include liquid directing channels operable to conduct liquid from proximal ends of the tines (that is the ends connected in liquid transferring relation with a co-operable opening of the reservoir), to distal ends of the tines having distal end channel openings through which to topically transfer liquid when positioned in supradermal relation beneath the animals coat.

More particularly, that topical dispensing of the liquid is particularly facilitated by the reservoir comprising a graspable bulb-configured handle providing waisted (i.e. as in having a waist, located generally intermediate the tines and the balance of the handles protuberant bulb), radially opposed accommodation for an operator's opposed digits, around the periphery of the bulb's protuberant extension, preferably in general longitudinal alignment with and above the tines.

In accordance with one aspect of the present invention, the topical supradermal applicator is provided as a kit comprising: a graspable bulb-configured handle providing radially opposed accommodation for an operator's opposed digits, around the periphery of said bulb and providing a liquid reservoir; one or more interchangeable manifold plates including a plurality of applicator tines each generally as described above, (but optionally having respectively different tine characteristics such as numbers and mutual proximity of tines or tine lengths for example); and, a reservoir is adapted to be coupled in liquid transferring relation with said plurality of applicator tines.

The present invention makes further provision for a method of use of the applicator's described herein, including a method for topical supradermal application of a liquid to an animal having a coat covered epidermis comprising grasping a resilient bub-shaped handle with digits positioned to act in mutually opposed relation around the periphery of the bulb; and positioning the applicator with the common longitudinal axis of the handle and associated applicator tines, with the tines extending through an animal's coat and proximal to a dermal surface; and compressing the bulb by mutually convergent action of flexing digits to express liquid from the reservoir and thereby transferring it through the tines to be applied as a topical supradermal application beneath the animal's coat.

### Advantageous Effects

The present invention affords potential advantages over other prior applicators, and these manifest in the facility of the application method associated with the invention's use.

The bulb handle facilitates orientation and positioning relative to the pet's body, and in particular making it easier to negotiate the repositioning of the applicator around the pet's body, (e.g. maneuvering the applicator around and between the juncture of the legs and the trunk of the body). This is especially so when compared with the very typical laterally offset handle arrangements in the prior art, that were a carry-over from appliances useful in grooming human hair. This is true even when compared with the flat palm applicators (recalling for example '214 and '492 patents mentioned previously herein), because the grasp afforded by the bulb of the present invention allows a user to use the additional degrees of freedom of motion to precisely position and move the present applicator with the more refined dexterity afforded by the operator's fingers.

The co-commensurate size of some embodiments (i.e. where the mutual lateral extent of the bulb and the array of tines), all aligned on a common axis, make it easier for an operator to visualize/feel the pattern/extent/localization of the applied treatment underneath the coat, (which again, is an advantage pertinent for both the applicator and the method hereof).

The indentations provided in some embodiments, on the bulb facilitate control in moving the applicator through the coat—but they also help to keep the operator's fingers mutually separated to facilitate the squeezing action required for filling/dispensing.

Is aspects of the invention where the applicator is adapted to float, (e.g. in a pail of prepared treatment solution), it can be adapted to floats upright with the bulb presenting itself for ease of location and grasping orientation while the operator keeps the balance of his/her attention on managing the animal.

The generally circular array provides for better localization of application, unlike the awkward elongation of a prior art combs or brushes which can easily overextend beyond or out of contact with a targeted body surface.

The compressible resilient bulb facilitates both controlled dispense and refilling of the integral reservoir, and in some embodiments, can both apply and vacuum or draw back excess treatment solution onto/from a targeted body surface, as an aid to ensuring proper coverage/dosing of the body surface under treatment. In this latter aspect the application of “leave-it-on” medications in some instances only requires a fairly localized deposit of relatively minor amounts of solution, so the resilient bulb can be compressed to deliver an amount, and then released to draw back solution that has not immediately dispersed from the tines' points of application—rendering an efficient and appropriate localization of the treatment in question.

### BRIEF DESCRIPTION OF THE DRAWINGS

A clear understanding of the key features of the invention summarized above may be had by reference to the appended drawings, which illustrate the apparatus and method of the invention, although it will be understood that such drawings depict only certain embodiments of the invention and, therefore, are not to be considered as limiting its scope with regard to other embodiments in which the invention is capable of contemplating. Accordingly:

FIG. 1 is an illustration of the method and system of this invention showing a simplified diagram of the application device and its components, with a liquid solution held within the reservoir.

FIG. 2 is an illustration of the method and system of this invention showing a simplified diagram of the application device on the animal.

FIG. 3 is an illustration of the method and system of this invention showing a simplified diagram of the brush tips and the coat of the animal.

FIG. 4 is an illustration of the method and system of this invention showing a simplified diagram of the motion the user applies to the device to dispense liquid throughout the skin and coat of the animal.

FIG. 5 is an illustration of the method and system of this invention showing a simplified diagram of the interchangeable tips that may be used with the application device for various lengths and thicknesses of coats.

FIG. 6 is an illustration of the method and system of this invention showing a simplified diagram of the perforated tips by which liquid is passed from the reservoir and onto the skin the animal.

### DESCRIPTION OF EMBODIMENTS

### Detailed Description of the Invention

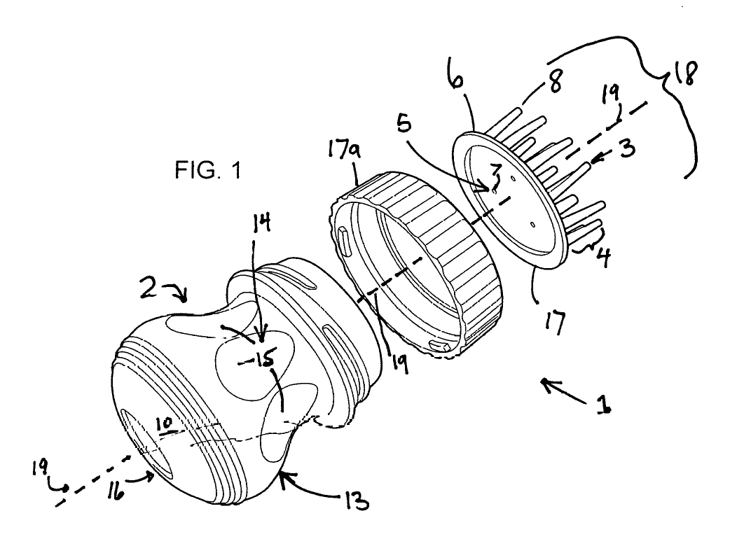

Referring to FIG. 1, the application device is broken down by component. The reservoir is shown filled with liquid, followed by the seal, which holds the tip plate on to the reservoir.

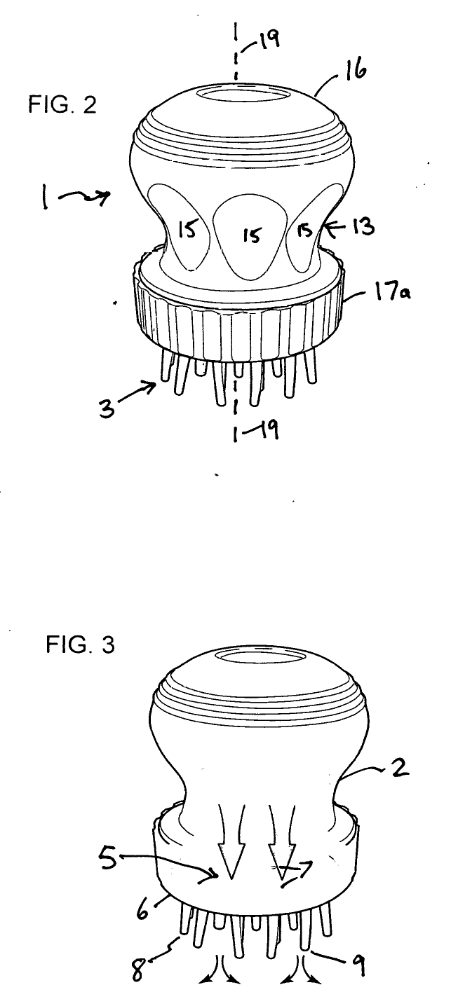

FIG. 2 depicts the assembled application device placed on the animal's body as outlined in this method. The application device allows the liquid to be held until placed on the animal's skin for release.

In FIG. 3, the application device is shown placed on the animal's body with the tips parting the coat to allow liquid to be dispensed directly onto the skin of the animal by the user. The interchangeable tips will vary in thickness and flexibility depending on the animal's coat length and thickness. Liquid can be dispersed through the perforated tips in a controlled manner.

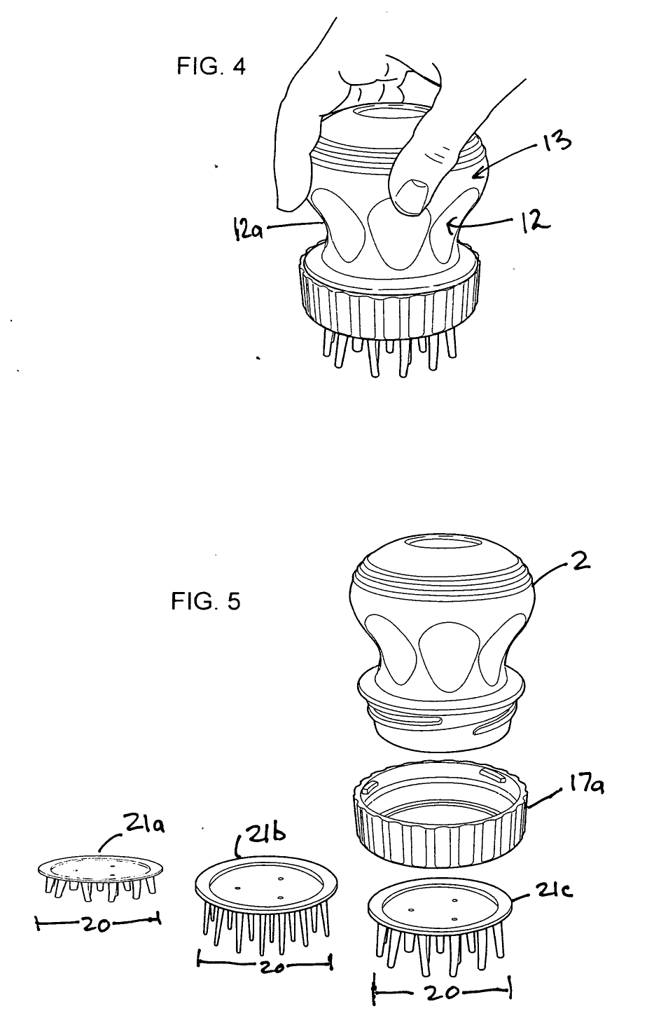

FIG. 4 depicts the brushing movement applied to work the liquid into the skin and coat once the liquid is dispersed, or while the liquid is dispersed.

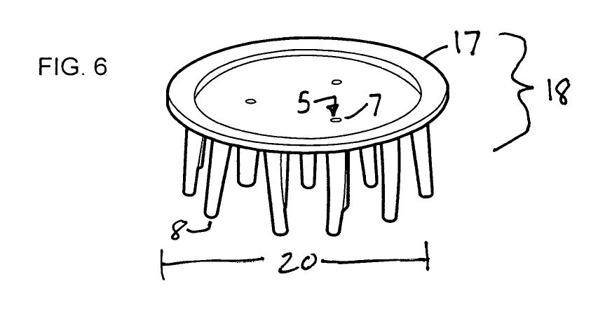

FIG. 5 is an illustration of the interchangeable tips, allowing for liquid application to the skin of animals with varying coat thicknesses and lengths. Each tip upper plate will have a similar dimension, while the tips themselves will vary depending on the need of the user.

FIG. 6 depicts a possible layout of the tips on the tip plate. The size of the perforation as well as the amount of perforated tips will vary the speed that the liquid is released onto the skin of the animal.

Referring now to the drawings in general, (where not all features are represented in each view), there is shown a topical supradermal applicator 1 comprising a liquid reservoir 2. Reservoir 2 is adapted to be coupled in liquid transferring relation with a plurality of applicator tines 3 each having a longitudinal extent 4 adapted to bypass an animals coat and including liquid directing channels 5 operable to conduct liquid from proximal ends 6 thereof connected in liquid transferring relation with a co-operable opening 7 from the reservoir, to distal ends 8 of the tines and there to topically transfer liquid through distal end channel openings 9. Openings 9 are adapted to be positioned in supradermal relation beneath the animal's coat for topical dispensing of the liquid. Reservoir 2 comprises a graspable bulb-configured handle 10 providing radially opposed accommodation for an operator's opposed digits 12, 12a, around the periphery 13 of said bulb handle 10. Handle 10 could be an oblate spheroid shape with a connecting waist portion intermediate the crown and the opposite end adapted to engage with the manifold plate.

Bulb handle sizes can vary, but are preferably about 4 inches to about 1 inch, and more typically in the range of about 3 to 1.5 inches. Handle 10 preferably comprises a compressible resilient bulb material and may have a textured surface to improve an operator's grip. More particularly, the bulb-configured handle 10 may comprise a circumferentially-disposed radial array 14 of graspable indents 15. The bulb handle 10 preferably includes a crown portion 16 arranged in diametric opposition to the co-operable opening 7, with the crown portion 16 oriented to face palm-ward to an operator's hand when grasped for use.

Applicator 1 includes proximal ends 6 of tines 3 that originate from a common manifold plate 17 adapted to be secured to reservoir 2. Plate 17 bears an array 18 of mutually spaced apart tines 3 and is preferably a circular plate and with array 18 of mutually spaced apart tines being a corresponding circular array. It is also preferred that array 18 of tines 3 and handle 10 be arranged in mutually assembled relation around a common longitudinal axis 19 and also that handle 10 periphery 13 circumscribe the circular array 18 of the applicator tines 3 to define an application footprint 20. This arrangement is particularly useful in targeting a localized treatment area.

The present invention also relates to a topical supradermal applicator kit comprising (whose component parts are perhaps best represented in exploded view in FIG. 1), with multiple plates 21a, 21b and 21c best shown in FIG. 5.

A method for topical supradermal application of a liquid to an animal having a coat covered epidermis comprising grasping a resilient bub-shaped handle 10 with digits 12, 12a positioned to act in mutually opposed relation around the periphery 13 of the bulb handle 10, and positioning the applicator 1 with the common longitudinal axis 19 of the handle 10 and associated applicator tines 3, with the tines extending through an animal's coat and proximal to a dermal surface, compressing the bulb 10 by mutually convergent action of flexing digits to express liquid from the reservoir 2 and thereby transferring it through the tines 3 to be applied as a topical supradermal application beneath the animal's coat. Preferably the bulb handle 10 and tines 3 are positioned with the common longitudinal axis 19 arranged in a generally normal orientation relative to a body surface to be treated and comprising the further step of repositioning the handle 10 to achieve topical supradermal application coverage below the coat.

### INDUSTRIAL APPLICABILITY

The present invention is susceptible of industrial application in relation to the manufacture and use of the applicator described herein and including its use for the grooming and healthcare of animals.

### REFERENCE SIGNS LIST

topical supradermal applicator 1;

liquid reservoir 2

applicator tines 3

a longitudinal extent 4

liquid directing channels 5

proximal ends 6

a co-operable opening 7

distal ends 8

distal end channel openings 9

graspable bulb-configured handle 10

waisted radially opposed accommodation 11

operator's opposed digits 12, 12a

periphery 13

circumferentially-disposed radial array 14

graspable indents 15

crown portion 16

a common manifold plate 17

manifold plate seal 17a

array (of mutually spaced apart tines) 18

a common longitudinal axis 19

tines application footprint 20

interchangeable manifold plates 21a, 21b, 21c

### CITATION LIST

### Patent Literature

U.S. Pat. No. 2,139,904

U.S. Pat. No. 2,922,425

U.S. Pat. No. 5,845,603

U.S. Pat. No. 6,024,052

U.S. Pat. No. 6,109,214

U.S. Pat. No. 6,367,421

U.S. Pat. No. 6,378,529

U.S. Pat. No. 6,637,440

U.S. Pat. No. 7,234,419

U.S. Pat. No. 7,926,492

U.S. Pat. No. 8,118,036

### Non Patent Literature

Not applicable

1. A topical supradermal applicator comprising a liquid reservoir adapted to be coupled in liquid transferring relation with a plurality of applicator tines each having a longitudinal extent adapted to bypass an animals coat and including liquid directing channels operable to conduct liquid from proximal ends thereof connected in liquid transferring relation with a co-operable opening of the reservoir, to distal ends of the tines and there to topically transfer liquid through distal end channel openings adapted to be positioned in supradermal relation beneath said coat for topical dispensing of said liquid and wherein said reservoir comprises a graspable bulb-configured handle providing waisted radially opposed accommodation for an operator's opposed digits, around the periphery of said bulb.

2. The applicator according to claim 1, wherein said handle comprises a compressible resilient bulb.

3. The applicator according to claim 1, wherein said bulb-configured handle comprises a circumferentially-disposed radial array of graspable indents.

4. The applicator according to claim 1, wherein said bulb includes a crown portion arranged in diametric opposition to said co-operable opening facing palm-ward to an operator's hand.

5. The applicator according to claim 1, wherein proximal ends of said tines originate from a common manifold plate adapted to be secured to said reservoir.

6. The applicator according to claim 5, wherein said plate bears an array of mutually spaced apart tines.

7. The applicator according to claim 6, wherein said plate is a circular plate and said array of mutually spaced apart tines is a circular array.

8. The applicator according to claim 5, wherein said array of tines and said handle are adapted to be arranged in mutually assembled relation around a common longitudinal axis.

9. The applicator according to claim 7, wherein said handle periphery circumscribes the circular array of said applicator tines application footprint.

10. A topical supradermal applicator kit comprising:
a. a graspable bulb-configured handle providing radially opposed accommodation for an operator's opposed digits, around the periphery of said bulb and providing a liquid reservoir;
b. one or more interchangeable manifold plates including a plurality of applicator tines each having a longitudinal extent adapted to bypass an animals coat and including liquid directing channels operable to conduct liquid from proximal ends to distal ends of the tines and there to topically transfer liquid through distal end channel openings adapted to be positioned in supradermal relation beneath said coat for topical dispensing of said liquid; and,
c. wherein said reservoir is adapted to be coupled in liquid transferring relation with said plurality of applicator tines, to transfer liquid to proximal ends thereof connected in liquid transferring relation from a co-operable opening of the reservoir.

11. A method for topical supradermal application of a liquid to an animal having a coat covered epidermis comprising grasping a resilient bub-shaped handle with digits positioned to act in mutually opposed relation around the periphery of the bulb, and positioning the applicator with the common longitudinal axis of the handle and associated applicator tines, with the tines extending through an animal's coat and proximal to a dermal surface, compressing the bulb by mutually convergent action of flexing digits to express liquid from the reservoir and thereby transferring it through the tines to be applied as a topical supradermal application beneath said coat.

12. The method of claim 11, wherein the bulb and tines are positioned with the common longitudinal axis arranged in a generally normal orientation relative to a body surface to be treated and comprising the further step of repositioning the handle to achieve topical supradermal application coverage below the coat.
